(19) United States
(12) Patent Application Publication
(10) Pub. No.: US 2012/0026181 A1
(43) Pub. Date: Feb. 2, 2012

(54) VIEWABLE BOUNDARY FEEDBACK

(75) Inventors: Mark Wagner, Clyde Hill, WA (US); Michael Reed, Chapel Hill, NC (US)

(73) Assignee: GOOGLE INC., Mountain View, CA (US)

(21) Appl. No.: 12/847,335

(22) Filed: Jul. 30, 2010

(51) Int. Cl. G09G 5/00; G09G 5/10

(52) U.S. Cl. 345/589; 345/647

(57) ABSTRACT

In general, this disclosure describes example techniques to distort one or more visible attributes of an image content portion when a user requests to extend an image content portion beyond a boundary of the image content. A device, such as, but not limited to, a mobile device may receive a request that is based on a user gesture to extend the image content portion beyond a boundary of the image content. The device may, in response to the request, distort one or more visible attributes of the image content portion to indicate recognition of the request and to further indicate that the request will not be processed to extend the portion of the image content beyond the boundary of the image content.

### TECHNICAL FIELD

This disclosure relates to providing user feedback regarding a boundary of displayed content.

### BACKGROUND

Devices such as mobile devices and desktop computers are configured to display image content such as documents, e-mails, and pictures on a screen. In some instances, rather than displaying the entire image content, the screen displays a portion of the image content. For example, rather than displaying every single page in a document, the screen may display only the first page when the document is opened. To transition from one portion of the image content to another portion of the image content, the user may scroll the image content in two dimensions, e.g., up-down or right-left.

The devices may also allow the user to zoom-in or zoom-out of the displayed image content. Zooming into the image magnifies part of the image content. Zooming out of the image content provides large amounts of displayed image content on a reduced scale.

There may be a limit as to how much a user can scroll and zoom on the displayed image content. For example, if the image content is displaying the first page, the user may not be allowed to scroll further up. If the image content is displaying the last page, the user may not be able to scroll further down. There may also be practical limitations on how far the user can zoom-in or zoom-out of the image content. For example, the device may limit the user from zooming in any further than 1600% or zooming out any further than 10% for the displayed image content.

### SUMMARY

In one example, aspects of this disclosure are directed to a computer-readable storage medium comprising instructions that cause one or more processors of a computing device to receive a request that is based upon a user gesture to extend an image content portion of image content beyond a boundary of the image content, wherein the image content portion is currently displayed on a display screen and within the boundary of the image content, and responsive to receiving the request, distort one or more visible attributes of the image content portion that is displayed on the display screen to indicate recognition of the request and to further indicate that the request will not be processed to extend the image content portion beyond the boundary of the image content.

In another example, aspects of this disclosure are directed to a method comprising receiving, with at least one processor, a request that is based upon a user gesture to extend an image content portion beyond a boundary of the image content, wherein the image content portion is currently displayed on a display screen and within the boundary of the image content, and responsive to receiving the request, distorting, with the at least one processor, one or more visible attributes of the image content portion that is displayed on the display screen to indicate recognition of the request and to further indicate that the request will not be processed to extend the image content portion beyond the boundary of the image content.

In another example, aspects of this disclosure are directed a device at least one processor configured to receive a request that is based upon a user gesture to extend an image content portion beyond a boundary of the image content, wherein the image content portion is currently displayed on a display screen and within the boundary of the image content, and means for distorting one or more visible attributes of the image content portion that is displayed on the display screen to indicate recognition of the request and to further indicate that the request will not be processed to extend the image content portion beyond the boundary of the image content, in response to the request.

Aspects of this disclosure may provide some advantages. The distortion of the visible attributes of the content may indicate to the user that the user is attempting to extend a portion of the image content beyond a content boundary. In aspects of this disclosure, the user is provided an indication that his or her request to extend beyond the boundary is recognized by the distortion to the visible attributes of the content. Otherwise, it may be possible that the user may not know that the device recognized the attempt, and may conclude that the device is malfunctioning.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIGS. 1A-1E are screen illustrations of scrolling an image content portion in accordance with one or more aspects of this disclosure.

FIGS. 2A-2C are screen illustrations of zooming an image content portion in accordance with one or more aspects of this disclosure.

FIG. 3 is a block diagram illustrating an example device that may function in accordance with one or more aspects of this disclosure.

FIG. 4A is a screen illustration illustrating an example of an image content portion.

FIGS. 4B and 4C are screen illustrations illustrating examples of distorting one or more visible attributes of the image content portion of FIG. 4A.

FIG. 5A is a flow chart illustrating an example method of one or more aspects of this disclosure.

FIG. 5B is a flow chart illustrating another example method of one or more aspects of this disclosure.

### DETAILED DESCRIPTION

Certain aspects of the disclosure are directed to techniques to provide a user of a device with an indication that he or she has reached a boundary of image content on a display screen of the device. Examples of the boundary of image content include a scroll boundary and a zoom boundary. Users of devices, such as mobile devices, may perform scroll and zoom functions with respect to the image content presented on a display screen. Scrolling the image content can be performed in one or two dimensions (up-down, or right-left), and provides the user with additional image content. Zooming into the images magnifies part of the image content. Zooming out of the images provides larger amounts of the image content on a reduced scale. Zooming may be considered as scrolling in the third dimension where the image content appears closer (zoom in) or further away (zoom out).

The scroll and zoom functions are typically bounded by boundaries. When at the end of the image content, the user cannot scroll the image content any further down. Similarly, when at the top of the image content, the user cannot scroll the image content any further up. The zoom functions may be bounded by practical limitations of the device. The device may support magnification only up to a certain level, and may not support additional magnification. Similarly, the device may be limited in the amount of the image content it can display and still be recognizable by the user.

When a user attempts to further extend the image content beyond these example viewable boundaries, e.g., a scroll boundary or a zoom boundary, in aspects of this disclosure, the device may distort one or more visible attributes of the image content to indicate to the user that he or she has reached such a boundary. Visible attributes of the image content may be considered as the manner in which the image content is displayed. For example, when the user attempts to further extend the image content beyond a boundary, the device may warp, curve, or shade at least some parts of the image content in response to the user's indication to extend a portion of the image content beyond the content's boundary. Warping or curving may include some distortion of at least some parts of the portion of the image content. Shading may include changing the color or brightness, e.g., lighting, of at least some parts of the portion of the image content to distort the portion of the image content.

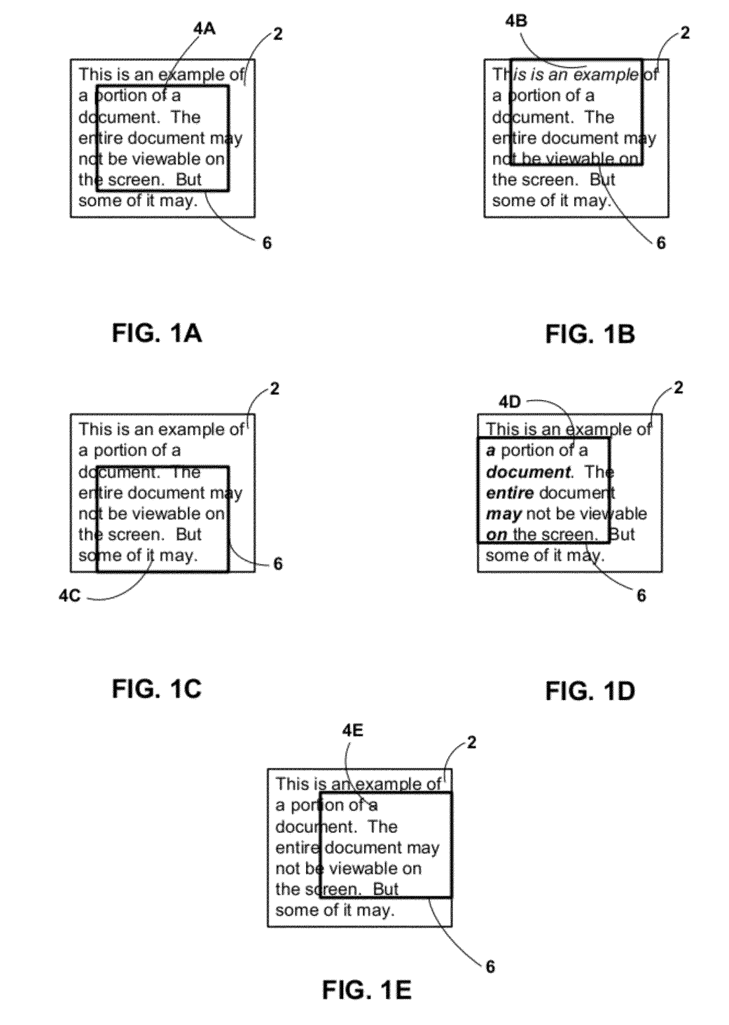

FIGS. 1A-1E are screen illustrations of scrolling an image content portion in accordance with one or more aspects of this disclosure. FIGS. 1A-1E illustrate image content 2, image content portion 4A-4E (collectively “image content portions 4”), and display screen 6. Display screen 6 may be a touch screen, liquid crystal display (LCD), e-ink, or other display. Display screen 6 may be a screen for a device such as, but not limited to, a portable or mobile device such as a cellular phone, a personal digital assistant (PDA), a laptop computer, a portable gaming device, a portable media player, an e-book reader, a watch, as well as a non-portable device such as a desktop computer.

As illustrated in FIGS. 1A-1E, image content 2 may be a document that includes words. However, image content 2 should not considered limited documents that include words. Image content 2 may be a picture, video, or any other type of image content. Image content portions 4 may be portions of image content 2 that are currently displayed to and viewable by the user on display screen 6. Image content portions 4 may be within the boundary of image content 2. Image content of image content 2 that is outside of image content portions 4 may not be displayed to the user.

As illustrated in FIG. 1A, image content portion 4A is approximately centered within image content 2. In some instances, the user may desire to view image content of image content 2 that is above or below image content portion 4A, or to the left or right of image content portion 4A. To view image content of image content 2 that is above or below image content portion 4A, the user may scroll image content portion 4A upward or downward via a corresponding user gesture. To view image content of image content 2 that is to the left or right of image content portion 4A, the user may scroll image content portion 4A leftward or rightward via a corresponding user gesture.

A user gesture, as used in this disclosure, may be considered as any technique to scroll the displayed image content portion, e.g., image content portions 4, upward, downward, leftward, rightward, or any possible combinational direction, e.g., diagonally. As described in more detail below, a user gesture may also be considered as any technique to zoom-in or zoom-out of the displayed image content portion.

The user gesture may be submitted via a user interface. Examples of the user interface include, but are not limited to, display screen 6, itself, in examples where display screen 6 is a touch screen, a keyboard, a mouse, one or more buttons, a trackball, or any other type of input mechanism. As one example, the user may utilize a stylus pen or one of the user's digits, such as the index finger, and place the stylus pen or digit on display screen 6, in examples where display screen 6 is a touch screen. The user may then provide a gesture such as dragging the digit or stylus pen upwards on display screen 6 to scroll image content portion 4A upwards. The user may scroll image content portion 4A downward, rightward, leftward, or diagonally in a substantially similar manner. As another example, the user may utilize the trackball and rotate the trackball with an up, down, right, left, or diagonal gesture to scroll image content portion 4A upward, downward, rightward, leftward, or diagonally.

It should be noted that in some instances, based on the example of the input mechanism, image content portion 4A may scroll in the opposite direction then the user gesture. However, the scrolling of image content portion 4A may still be based on the type of user gesture entered by the user. For example, if the user enters the user gesture via a mouse attached to a desktop computer, when the user scrolls downwards via the mouse, image content portion 4A may scroll upwards. Similarly, when the user scrolls upwards via the mouse, image content portion 4A may scroll downwards, when the user scrolls rightward via the mouse, image content portion 4A may scroll leftward, and when the user scrolls leftward, image content portion 4A may scroll rightward. Aspects of this disclosure are described in the context of image content portion 4A moving in the same direction as the user gesture. However, aspects of this disclosure should not be considered limited as such.

Although not shown in FIGS. 1A-1E, in some examples, display screen 6 may display a vertical scroll bar and a horizontal scroll bar. The vertical and horizontal scroll bars may allow the user to scroll image content portions 4 vertically and horizontally, respectively. The vertical and horizontal scroll bars may each include an indication of the location of image content portions 4 relative to image content 2.

Furthermore, it should be noted that the example techniques to scroll image content portions 4 are provided for illustration purposes only and should not be considered as limiting. In general, aspects of this disclosure may be applicable to any technique to allow a user to scroll image content portions 4 in a vertical direction, horizontal direction, right direction, left direction, diagonal direction, or in any combinational direction, e.g., in a circle.

In the examples illustrated in FIGS. 1A-1E, image content portions 4 may be currently displayed to the user on display screen 6. Image content portions 4 may be within the boundary of image content 2. Image content of image content 2 that is outside of image content portions 4 may not be displayed to the user.

As noted above, in FIG. 1A, image content portion 4A is approximately centered within image content 2. As illustrated in FIG. 1B, image content portion 4B represents image content portion 4A scrolled to the top-most end of image content 2. As illustrated in FIG. 1C, image content portion 4C represents image content portion 4A scrolled to the bottom-most end of image content 2. As illustrated in FIG. 1D, image content portion 4D represents image content portion 4A scrolled to the left-most end of image content 2. As illustrated in FIG. 1E, image content portion 4E represents image content portion 4A scrolled to the right-most end of image content 2. The ends of image content 2, e.g. the top-most end, bottom-most end, left-most end, and right-most end, may be considered as the scroll boundaries.

The example locations of image content portions 4 relative to image content 2, in FIGS. 1A-1E, are provided for illustration purposes only. In some examples, the user may scroll an image content portion in both the vertical and horizontal directions. For the example, the user may scroll an image content portion diagonally.

In some instances, after the user scrolled to a scroll boundary, the user may not realize that he or she scrolled to the scroll boundary. Scrolling beyond a scroll boundary may not be possible because there is no additional image content to be displayed. The user may, nevertheless, keep trying to scroll further than the scroll boundary. For example, the user may try to scroll image content portion 4B upwards, not realizing the image content portion 4B is at the scroll boundary. This may cause the user to become frustrated because the user may believe that his or her request for additional scrolling is not being recognized and may conclude that the device is malfunctioning.

In some aspects of this disclosure, one or more processors within the device that displays image content 2 and image content portions 4 on display screen 6 may receive a request based upon a user gesture to extend image content portions 4 beyond a scroll boundary. In response to the request, the one or more processors may distort one or more visible attributes of image content portions 4 to indicate recognition of the request and to further indicate that the request will not be processed to extend image content portions 4 beyond the scroll boundary. Examples of distorting the visible attributes include, but are not limited to, warping, curving, and shading at least some of image content portions 4. Warping or curving may include some distortion of at least some parts of the portion of the image content. Shading may include changing the color or brightness, e.g., lighting, of at least some parts of the portion of the image content to distort the portion of the image content.

In some examples, the one or more processors may distort the one or more visible attributes of image content portions 4 for a brief moment, e.g., for one second or less, however, the one or more processors may distort the visible attributes for other lengths of times. At the conclusion of the moment, e.g., after one second, the processors may remove the distortion to the visible attributes.

As one example, when the user attempts to further extend image content portion 4C downward beyond the scroll boundary, the one or more processors may warp, curve, and/or shade at least some parts of image content portion 4C to distort parts of image content portion 4C. The one or more processors may similarly warp, curve, and/or shade at least some parts of image content portions 4B, 4D, and 4E if the user attempts to further scroll beyond the upward, leftward, and rightward scroll boundaries, respectively, to distort parts of image content portions 4B, 4D, and 4E.

As another example, the user may request to extend image content portion 4B beyond the top scroll boundary. As illustrated in FIG. 1B, to indicate that the user is attempting to scroll beyond a scroll boundary, the one or more processors may italicize at least a part of image content portion 4B. Italicizing at least a part of image content portion 4B may be considered as another example of distorting visible attributes of the image content portion. For example, as illustrated in FIG. 1B, the phrase “is is an example,” within image content portion 4B, is italicized to indicate to recognition of the request to extent image content portion 4B beyond a scroll boundary.

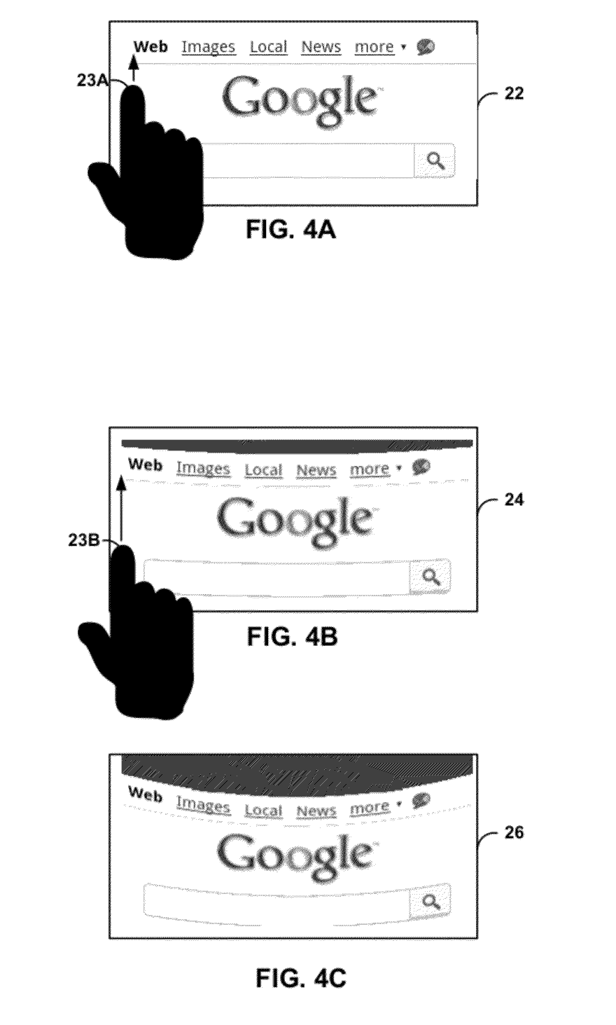

As another example, the user may request to extend image content portion 4D beyond the left scroll boundary. In response, the one or more processors may italicize at least a part of image content portion 4D to indicate that the user is attempting to scroll beyond a scroll boundary. However, the user may not see the italicized part of image content portion 4D, and may again request to extend image content portion 4D beyond the left scroll boundary. In some of these instances, the one or more processors may further distort visible attributes of image content portion 4D. For example, as illustrated by image content portion FIG. 4D, the one or more processors may italicize a part of image content portion 4D in response to a request to extend image content portion 4D beyond a scroll boundary. The one or more processor may then bold the part of image content portion 4D in response to another request to extend image content portion 4D beyond the scroll boundary after the one or more processors italicize the part of image content portion 4D. As illustrated in FIG. 1D, the words, “a,” “document,” “entire,” “may,” and “on,” are both italicized and bolded. Italicizing and bolding at least a part of image content portion 4D may be considered as another example of distorting visible attributes of the image content portion.

It should be noted that although FIGS. 1B and 1D illustrated that entire words are italicized or italicized and bolded, aspects of this disclosure are not so limited. In some examples, rather than the entire word, only some letters may be italicized or italicized and bolded. In some examples, rather than a part of the image content portion, the one or more processors may distort the entire image content portion in response to a request to extend the image content portion beyond a boundary. Also, in some examples, the one or more processors may underline letters or words to distort the visible attributes in response to a request to extend an image content portion beyond a boundary. In examples where the image content portion does not include words, and even in examples where the image content portion includes words, the one or more processors may warp, curve, or shade at least a part of the image content portion. In general, aspects of this disclosure are not limited to the examples of distortions to visible attributes described above. Rather, aspects of this disclosure include any technique to distort visible attributes in response to a request to extent an image content portion beyond the scroll boundary.

The distortion of the visible attributes may indicate to the user that the user is attempting to extend an image content portion, for example, but not limited to, one of image content portions 4, beyond the scroll boundary. Moreover, the distortion of the visible attributes may indicate to the user that the user's request to extend an image content portion beyond the scroll boundary is recognized, but will not be processed. In this manner, the user may recognize that the device is operating correctly, but the request to extend an image content portion will not be processed because the image content portion is at the scroll boundary.

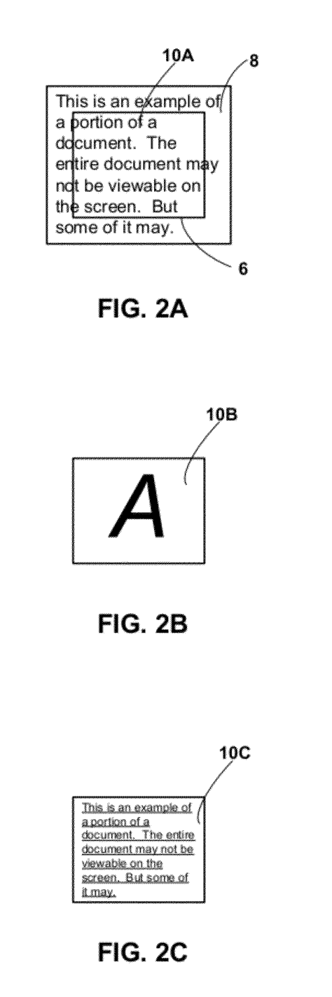

FIGS. 2A-2C are screen illustrations of zooming an image content portion in accordance with one or more aspects of this disclosure. In addition to or instead of scrolling an image content portion in the vertical or horizontal direction, in some instances, the user may desire to zoom into the image content or zoom out of the image content. Zooming into the image content may magnify part of the image content. Zooming out of the image content provides larger amounts of image content.

FIG. 2A illustrates image content 8 which may be similar to image content 2 (FIGS. 1A-1E). Image content 8 may include image content portion 10A which may be similar to image content portion 4A. Image content 10A may be displayed on display screen 6.

In some instances, the user may desire to zoom into image content of image content 8 to magnify some portion of image content 8. Similarly, the user may desire to zoom out of the image content that is currently displayed to display larger amounts of image content 8. However, the zoom functions may be bounded by practical limitations. Image content 8 may be magnified only up to a certain level, and may not be magnified any further. Similarly, there may be a limit in the amount of image content 8 that can displayed and still be recognizable by the user.

To zoom into or out of image content 8, the user may provide a user gesture in a substantial similar manner as described above. As one example, display screen 6 may display a zoom in button and a zoom out button. The user may tap the location on display screen 6 that displays the zoom in button to zoom in, and may tap the location on display screen 6 that displays the zoom out button to zoom out, in examples where display screen 6 is a touch screen. As another example, the user may place two digits, e.g., the index finger and thumb, on display screen 6. The user may then provide a multi-touch user gesture of extending the index finger and thumb in opposite directions, relative to each other, to zoom in.

However, like scrolling, there may be a boundary beyond which the user cannot zoom in or zoom out any further. The boundary beyond which the user cannot zoom in or zoom out may be referred to as a zoom boundary. The zoom boundary may be a function of the practical limitations of zooming. As one example, the user may not be allowed to magnify, e.g., zoom in, by more than 1600%. As another example, the user may not be allowed to zoom out to less than 10%. In these examples, the zoom boundaries maybe 1600% and 10%.

As illustrated in FIG. 2B, image content portion 10B represents image content portion 10A zoomed in up to the zoomed boundary. As illustrated in FIG. 2C, image content portion 10C represents image content portion 10A zoomed out up to the zoom boundary. Image content of image content 8 that is outside of image content portion 10B may not be displayed to the user. If there is any image content of image content 8 that is outside of image content 10C, such image content may also not be displayed to the user.

Similar to the scrolling examples provided above with respect to FIGS. 1A-1E, in some instances, after the user zooms in or out up to a zoom boundary, the user may not realize that he or she zoomed in or out up to the zoom boundary, and may try to zoom further than the zoom boundary. This may also cause the user to become frustrated because the user may believe that his or her request for additional zooming is not being recognized and, like the above example for scroll boundary, may conclude that the device is malfunctioning.

In some aspects of this disclosure, one or more processors within the device that displays image content 8 and image content portions 10A-10C on display screen 6 may receive a request based upon a user gesture to extend image content portions 10B and 10C beyond a zoom boundary. In response to the request, the one or more processors may distort one or more visible attributes of image content portion 10B and 10C to indicate recognition of the request and to further indicate that the request will not be processed to extend image content portions 10A and 10B beyond the zoom boundary. Examples of distorting visible attributes include, but are not limited to, warping, curving, and shading at least some of image content portions 10A and 10B. Additional examples of distorting visible attributes include, but are not limited to, bolding, italicizing, underlining, and the like, as well as, any combination thereof

For example, as illustrated in FIG. 2B, after the user attempts to zoom in further than the zoom boundary, the one or more processors may italicize at least a part of image content portion 10B. As another examples, as illustrated in FIG. 2C, after the user attempts to zoom out further than the zoom boundary, the one or more processors may underline at least a part of image content portion 10C.

Furthermore, as described above with respect to FIGS. 1A-1E, In some examples, the one or more processors may distort the one or more visible attributes of image content portions 10 for a brief moment, e.g., for one second or less, however, the one or more processors may distort the visible attributes for other lengths of times. At the conclusion of the moment, e.g., after one second, the processors may remove the distortion to the visible attributes. For example, after the one or more processors distort image content portion 10A, as shown in FIGS. 2B and 2C, the one or more processor may remove the distortion to the visible attributes after a brief moment so that the image content portion is displayed in a substantially similar manner as image content portion 10A.

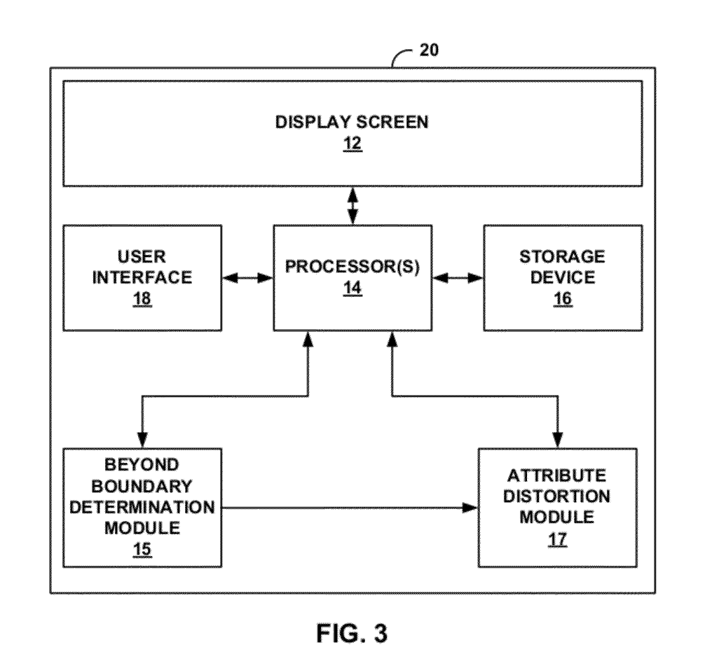

FIG. 3 is a block diagram illustrating an example device that may function in accordance with one or more aspects of this disclosure. Device 20 may include display screen 12, one or more processors 14, storage device 16, beyond boundary determination module 15, and attribute distortion module 17, and user interface 18. Examples of device 20 include, but are not limited to, a portable or mobile device such as a cellular phone, a personal digital assistant (PDA), a laptop computer, a portable gaming device, a portable media player, an e-book reader, a watch, as well as a non-portable device such as a desktop computer.

Device 20 may include additional components not shown in FIG. 3 for purposes of clarity. For example, device 20 may include a speaker and microphone to effectuate telephonic communication, in examples where device 20 is a cellular phone. Device 20 may also include a battery that provides power to the components of device 20 and a network interface that provides communication between device 20 and one or more other devices such as a server. Moreover, the components of device 20 shown in FIG. 3 may not be necessary in every example of device 20. For example, user interface 18 and display screen 12 may be external to device 20, in examples where device 20 is a desktop computer.

Display screen 12 may be substantially similar to display screen 6 (FIGS. 1A-1E and 2A-2C). For example, display screen 12 may be a touch screen, a liquid crystal display (LCD), an e-ink, or other display. Display screen 12 presents the content of device 20 to the user. For example, display screen 12 may present the applications executed on device 20 such as an application to display a document, a web browser or a video game, content retrieved from external servers, and other functions that may need to be presented. Furthermore, in some examples, display screen 12 may allow the user to provide the user gesture to scroll the image content or zoom into or out of the image content.

User interface 18 allows a user of device 20 to interact with device 20. Examples of user interface 20 include a keypad embedded on device 20, a keyboard, a mouse, one or more buttons, a trackball, or any other type of input mechanism that allows the user to interact with device 20. In some examples, user interface 18 may allow the user to provide the user gesture to scroll the image content or zoom into or out of the image content.

In some examples, display screen 12 may provide some or all of the functionality of user interface 18. For example, display screen 12 may be a touch screen that allows the user to interact with device 20. In these examples, user interface 18 may be formed within display screen 12. In some examples where display screen 12 provides some or all of the functionality of user interface 18, user interface 18 may not be necessary on device 20. However, in some examples where display screen 12 provides some or all of the functionality of user interface 18, device 20 may still include user interface 18 for additional ways for the user to interact with device 20.

One or more processors 14 may include any one or more of a microprocessor, a controller, a digital signal processor (DSP), an application specific integrated circuit (ASIC), a field-programmable gate array (FPGA), or equivalent discrete or integrated logic circuitry. One or more processors 14 may execute applications stored on storage device 16. For ease of description, aspects of this disclosure are described in the context of a single processor 14. However, it should be understood that aspects of this disclosure described with a single processor 14 may be implemented in one or more processors. When processor 14 executes the applications, processor 14 may generate image content such as image content 2 (FIGS. 1A-1E) and image content 8 (FIG. 2A).

In addition to storing applications that are executed by processor 14, storage device 16 may also include instructions that cause processor 14, beyond boundary determination module 15, and attribute distortion module 17 to perform various functions ascribed to processor 14, beyond boundary determination module 15, and attribute distortion module 17 in this disclosure. Storage device 16 may be a computer-readable, machine-readable, or processor-readable storage medium that comprises instructions that cause one or more processors, e.g., processor 14, beyond boundary determination module 15, and attribute distortion module 17, to perform various functions.

Storage device 16 may include any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media. Storage device 16 may be considered as a non-transitory storage medium. The term “non-transitory” means that storage device 16 is not a carrier wave or a propagated signal. However, the term “non-transitory” should not be interpreted to mean that storage device 16 is non-movable. As one example, storage device 16 may be removed from device 20, and moved to another device. As another example, a storage device, substantially similar to storage device 16, may be inserted into device 20.

As described above, in some instances, the user may attempt to scroll image content beyond a scroll boundary to zoom image content beyond a zoom boundary. As used in this disclosure, the term boundary may include both or either of the scroll boundary and the zoom boundary. Processor 14 may be configured to receive the request that is based upon a user gesture to scroll or zoom an image content portion such as image content portion 4A (FIG. 1A) or image content portions 10A (FIG. 2A). In some examples, processor 14 may be configured to receive a request to extend an image content portion beyond a boundary of the image content, e.g., extend scrolling beyond a scroll boundary and/or extend zooming beyond a zoom boundary.

In some examples, the boundary of the image content, such as the scroll boundary, may be defined by the ends of image content, e.g., locations within the image content beyond which there is no image content. In some examples, the boundary of the image content, such as zoom boundary, may be defined by the practical limitations of device 20. Processor 14 may be configured to identify the boundary, e.g., the scroll boundary and/or the zoom boundary based on the type of application executed by processor 14 that generated the image content. Processor 14 may provide such boundary information to beyond boundary determination module 15.

In addition, processor 14 may provide the request to extend the image content to beyond boundary determination module 15. Beyond boundary determination module 15 may be configured to determine whether the request to extent the image content portion includes a request to extent the image content portion beyond the boundary of the image content. For example, beyond boundary determination module 15 may compare the request to extend the image content portion with the boundary of the image content to determine whether the request to extent the image content portion includes a request to extend the image content portion beyond the boundary of the image content.

If the requests includes the request to extend the image content portion beyond the boundary of the image content, beyond boundary determination module 15 may indicate to attribute distortion module 17, that the user is requesting to extend the image content portion beyond the boundary of the image content. In response to the request, attribute distortion module 17 may be configured to distort one or more visible attributes of the image content portion to indicate recognition of the request and to further indicate that the request will not be processed to extend the image content beyond the boundary of the image content. Non-limiting examples of the functionality of attribute distortion module 17 include distorting one or more visible attributes such as warping, curving, or shading parts of the image content portion or the entire the image content portion.

Attribute distortion module 17 may distort one or more visible attributes of the image content portion at a location substantially close to the boundary when the user requests to extend the image content portion beyond a boundary. For example, if the user attempts to the scroll the image content portion above the top scroll boundary, as determined by beyond boundary determination module 15, attribute distortion module 17 may warp the top part of the image content portion. As another example, if the user attempts to zoom in the image content portion more than the zoom boundary, as determined by beyond boundary determination module 15, attribute distortion module 17 may shade the middle part of the image content portion. Attribute distortion module 17 may distort, e.g., warp, curve, or shade, parts of the image content portion when the user attempts to extend the image content portion beyond the bottom, right, left, or zoom out boundaries in a substantially similar fashion. Warping, curving, and shading are provided merely as examples of distortions to the visible attributes. In some examples, attribute distortion module 17 may be configured to distort the visible attributes in a manner different than warping, curving, and/or shading.

In some examples, attribute distortion module 17 may be configured to distort the one or more visible attributes based on the characteristic of the user gesture to extend the image content portion beyond the boundary. The characteristic of the user gesture may include characteristics such as how fast the user applied the user gesture, how many times the user applied the user gesture, the location of the user gesture, e.g., starting and ending locations of the user gesture, an amount the user requested to extend the image content beyond the boundary and the like. The user gesture characteristics may be identified by processor 14. Processor 14 may provide the user gesture characteristics to attribute distortion module 17. In some instances, attribute distortion module 17 may be configured to distort the one or more visible attribute more for a given user gesture characteristic than for other user gesture characteristics.

As one example, the user may provide a user gesture to scroll an image content portion upwards when the image content portion is at the scroll boundary. If the user gesture started at the bottom of display screen 12 and extended all the way to the top of display screen 12, attribute distortion module 17 may warp at least some of the image content portion more than the amount that attribute distortion module 17 would warp at least some of the image content portion if the user gesture started at the middle of display screen 12 and extended almost to the top of display screen 12.

As another example, the user may provide a user gesture to zoom into an image content portion when the image content portion is at the zoom boundary. The user gesture may be tapping a location of display screen 12 that displays a zoom in button. If the user repeatedly tapped the zoom in button, at a relatively high tapping frequency, attribute distortion module 17 may shade at least some of the image content portion more than the amount that attribute distortion module 17 would shade at least some of the image content portion if there were fewer taps at a lower tapping frequency.

As described above, attribute distortion module 17 may be configured to distort one or more visible attributes of the image content portions when processor 14 receives a request to extend an image content portion beyond a boundary of the image content, as may be determined by beyond boundary determination module 15. As one example, to distort the one or more visible attributes of the image content portion, attribute distortion module 17 may distort primitives that represent the image content portion.

To display the image content, including the image content portion, processor 14 may map the image content to a plurality of primitives. The primitives may be lines or polygons such as triangles and rectangles. For purposes of illustration, aspects of this disclosure are described in the context of the primitives being triangles, although aspects of this disclosure are not limited to examples where the primitives are triangles.

Processor 14 may map the image content to a triangle mesh on display screen 12. The triangle mesh may include a plurality of triangles, where each triangle includes a portion of display screen 12. Processor 14 may map each of the plurality of triangles to the image content, including the image content portion. Each triangle in the triangle mesh may be defined by the location of its vertices on display screen 12. The vertices may be defined in two dimensions (2-D) or three dimensions (3-D) based on the type of image content. For example, some graphical image content may be defined in 3-D or 2-D, and documental image content may be defined in 2-D.

To warp or curve a part of image content portion or the entire the image content portion, attribute distortion module 17 may displace the vertices of the triangles that represent the image content portion. For example, attribute distortion module 17 may distort the vertex location of one or more triangles that represent the image content portion that is being extended beyond the boundary. The distortion of the vertex location may be performed in 2-D or 3-D based on the desired distortion of the one or more visible attributes. For example, distortion of the vertex location for curving may be performed in 2-D and distortion of the vertex location for warping may be performed in 3-D.

To shade a part of the image content portion or the entire image content portion, attribute distortion module 17 may distort the color or brightness of one or more triangles that represent the image content portion. The distortion of the shading of the one or more triangles may be performed in 2-D.

In some examples, the amount by which attribute distortion module 17 displaces one or more primitives, e.g., triangles, may be based on the user gesture characteristics, as described above. As one example, the displacement of the one or more primitives may be localized at the location where the user entered the user gesture. As another example, the displacement of the one or more primitives may be based on the direction and/or magnitude of the user gesture. The magnitude of the user gesture may be considered as the user gesture characteristics.

For instance, attribute distortion module 17 may displace, color, or brighten the one or more triangles that represent the image content portion based on the amount of times the user entered the user gesture and/or the location of the user gesture. If the user gesture started at the bottom of the image content portion on display screen 12 and extended to the top of display screen 12, and image content portion was at the scroll boundary, attribute distortion module 17 may displace the one or more triangles that represent the image content portion more than if the user gesture started at the middle of the image content portion and extended to the top of display screen 12. In another instance, for every time that the user enters a user gesture to zoom into the image content portion, when the image content portion is at the zoom boundary, attribute distortion module 17 may brighten more and more parts of the image content portion, or brighten parts of the image content portion more and more.

The displacement of the one or more primitives, e.g., triangles, and/or the changes in the color or brightness of the one or more primitives may indicate to the user that the image content portion is at a boundary, e.g., scroll boundary or zoom boundary. Such distortions in the visible attributes of the image content portion may indicate recognition of the request to extend the image content portion beyond the boundary, and may also indicate that the request will not be processed.

In some examples, the user of device 20, or some other entity, may select the manner in which attribute distortion module 17 will distort the image content portion in response to a request to extent the image content portion beyond a boundary. The user may select the primary distortion that is to be applied to the image content portion when the user requests to extend the image content portion beyond a boundary. The user may also select other distortions that are to be applied to the image content portion after at least one user request to extend the image content portion beyond a boundary.

For example, the user may select curving as the primary distortion that is applied to the image content portion when the user requests to extent the image content portion beyond a boundary. The user may select shading as the secondary distortion that is applied to the image content portion when the user requests to extent the image content portion beyond a boundary. At the first instance when the user requests to extent the image content beyond a boundary, attribute distortion module 17 may curve the image content portion. If the user attempts again to extent the image content beyond the boundary, attribute distortion module 17 may shade the image content portion.

It should be noted that in some examples, attribute distortion module 17 may remove the distortions to the one or more visible attributes after a brief moment. The user may then enter a subsequent user gesture to extent after attribute distortion module 17 removed the distortions to the visible attributes. However, aspects of this disclosure are not so limited. In some examples, the user may enter a subsequent user gesture before attribute distortion module 17 removed the distortions to the one or more visible attributes.

Attribute distortion module 17 and beyond boundary determination module 15 may be implemented in hardware, software, firmware, or a combination thereof. For example, attribute distortion module 17 and beyond boundary determination module 15 may be implemented in a microprocessor, a controller, a DSP, an ASIC, a FPGA, or equivalent discrete or integrated logic circuitry. Furthermore, although shown as separate units in FIG. 3, in some examples, attribute distortion module 17 and beyond boundary determination module 15 may be formed as a part of processor 14.

In some examples, in addition to distorting one or more visible attributes of the image content portion, device 20 may also provide non-visual indicators responsive to the request to extend the image content portion beyond a boundary of the image content. Non-limiting examples of the non-visual indicators include vibrations and sounds. As one example, in response to the request to extend the image content portion beyond the boundary of the image content, processor 14 may cause device 20 to vibrate. The vibration of device 20 may indicate recognition of the request and indicate that the request will not be processed. As another example, processor 14 may cause a speaker of user interface 18 to produce a sound, such as a “boing” sound, or any other sound, in response to the request to extend the image content portion beyond the boundary of the image content. Other examples of non-visual indicators may be possible and may be provided in response to the request to extend the image content portion beyond the boundary of the image content, in accordance with aspects of this disclosure. The non-visual indicators may work in conjunction with the visual indicators, e.g., distortion of the visible attributes, to indicate to the user that the image content portion is at a boundary, e.g., scroll or zoom boundary.

FIG. 4A is a screen illustration illustrating an example of an image content portion. FIGS. 4B and 4C are screen illustrations illustrating examples of distorting one or more visible attributes of the image content portion of FIG. 4A. FIG. 4A illustrates the Google™ search engine website, represented as image content portion 22. In the example illustrated in FIG. 4A, image content portion 22 is at a scroll boundary. A user may request to extent image content portion 22 beyond the scroll boundary.

As one example, the user may enter a user gesture via digit 23A, of the user's hand, to extend image content portion 22 beyond a boundary. As indicated in FIG. 4A, the user gesture may be a movement of digit 23 in an upward direction. Attribute distortion module 17 may distort parts of image content portion 22 in response to a user request to extent image content portion 22 beyond a scroll boundary.

FIG. 4B illustrates one example of distortion to image content portion 22, in response to a user request to extent image content portion 22 beyond a scroll boundary. In the example illustrated in FIG. 4B, image content portion 24 is a distorted version of image content portion 22. The example of FIG. 4B may result after the user enters a user gesture to scroll image content portion 22 beyond the scroll boundary. In response, attribute distortion module 17 may distort, e.g., curve, image content portion 22 as illustrated by image content portion 24.

As one example, attribute distortion module 17 may distort image content portion 22, as illustrated by image content portion 24 in FIG. 4B, when the user gesture indicates that the user requested to scroll image content 22 in an upward direction beyond the scroll boundary. The amount by which attribute distortion module 17 may distort image content portion 22 may be based on the user gesture characteristics. In some examples, the user gesture may be the first user gesture to scroll image content portion 22 beyond the scroll boundary, and in response, attribute distortion module 17 may distort image content portion 22 as illustrated by image content portion 24 in FIG. 4B. In some examples, the user gesture may start by the user placing a digit on the top of image content portion 22 and dragging the digit in an upward direction, as shown in FIG. 4A. In response, attribute distortion module 17 may distort image content portion 22 as illustrated by image content portion 24 in FIG. 4B.

Although not shown specifically in FIG. 4B, after attribute distortion module 17 distorts image content portion 22, such distortions may exist for a brief moment, e.g., one second, although the distortion may exist for other lengths of time. At the conclusion of the “brief moment,” attribute distortion module 17 may modify image content portion 24 such that there is no more distortion, e.g., the image content may be displayed as image content portion 22. However, it may possible for the user to enter a subsequent user gesture before attribute distortion module 17 removes the distortions to the visible attributes.

FIG. 4C illustrates another example of distortion to image content portion 22, in response to a user request to extent image content portion 22 beyond a scroll boundary. In the example illustrated in FIG. 4C, image content portion 26 is a distorted version of image content portion 22, and further distorted version of image content portion 24. The amount by which attribute distortion module 17 may distort image content portion 22, to generate image content portion 26, may be based on the user gesture characteristics. In some examples, the user gesture may be a subsequent user gesture, after the first user gesture, to scroll image content portion 22 beyond the scroll boundary, and in response, attribute distortion module 17 may distort image content portion 22 as illustrated by image content portion 26 in FIG. 4C.

For example, the user may enter a first user gesture to extent image content portion 22 beyond the scroll boundary, as illustrated by digit 23A in FIG. 4A. In response, attribute distortion module 17 may distort image content portion 22 as illustrated by image content portion 24 in FIG. 4B. It may be possible for the user to not recognize the distortion, as illustrated in FIG. 4B. The user may then enter another, subsequent user gesture to extent image content portion 22 beyond the scroll boundary, as illustrated by digit 23B in FIG. 4B. In response to this subsequent user gesture, attribute distortion module 17 may distort image content portion 22 more than the amount by which attribute distortion module 17 distorted image content portion 22, as illustrated in FIG. 4B. For example, in response to the subsequent user gesture, attribute distortion module 17 may distort image content portion 22 as illustrated by image content portion 26 in FIG. 4C.

It should be noted that in some examples, before the subsequent user gesture, the distortion of image content portion 24 may be removed. For example, the image content may be displayed in a substantially similar manner as image content portion 22.

In some examples, the user gesture may start by the user placing a digit on the middle of bottom of image content portion 22 and dragging the digit in an upward direction. In response, attribute distortion module 17 may distort image content portion 22 as illustrated by image content portion 26 in FIG. 4C. In this example, the magnitude of the user gesture, in the example illustrated by FIG. 4B, may be less than the magnitude of the user gesture, in the example illustrated by FIG. 4C.

For instance, as illustrated in FIG. 4A, the user may place digit 23A near the top of image content portion 22. As illustrated in FIG. 4B, the user may place digit 23B near the middle of image content portion 24. In these examples, the magnitude of the user gesture, illustrated by the arrow in FIG. 4A, is less than the magnitude of the user gesture, illustrated by the arrow in FIG. 4B. As illustrated in FIGS. 4B and 4C, the amount of distortion of image content portion 22 is greater in FIG. 4C, as illustrated by image content portion 26, relative to the amount of distortion of image content portion 22, as illustrated by image content portion 24, in FIG. 4B.

It should be noted that the examples of FIGS. 4B and 4C are provided for illustration purposes only. In some instances, in response to a user gesture to extend image content portion 22 beyond a boundary, e.g., a scroll or zoom boundary, attribute distortion module 17 may distort image content portion 22 in manners different than those illustrated by FIGS. 4A and 4B. For example, attribute distortion module 17 may warp or shade image content portion 22. As other examples, attribute distortion module 17 may underline, bold, or italicize parts of image content portion 22 or all of image content portion 22.

Furthermore, although digit 23A and digit 23B are shown as located on different parts of the image content, aspects of this disclosure are not so limited. In some examples, digit 23A and digit 23B may be located in the same location. For example, during subsequent user gestures, the user may place the digit, or any of the other input mechanisms, e.g., mouse location, stylus pen, or other input mechanisms, in a substantially similar location.

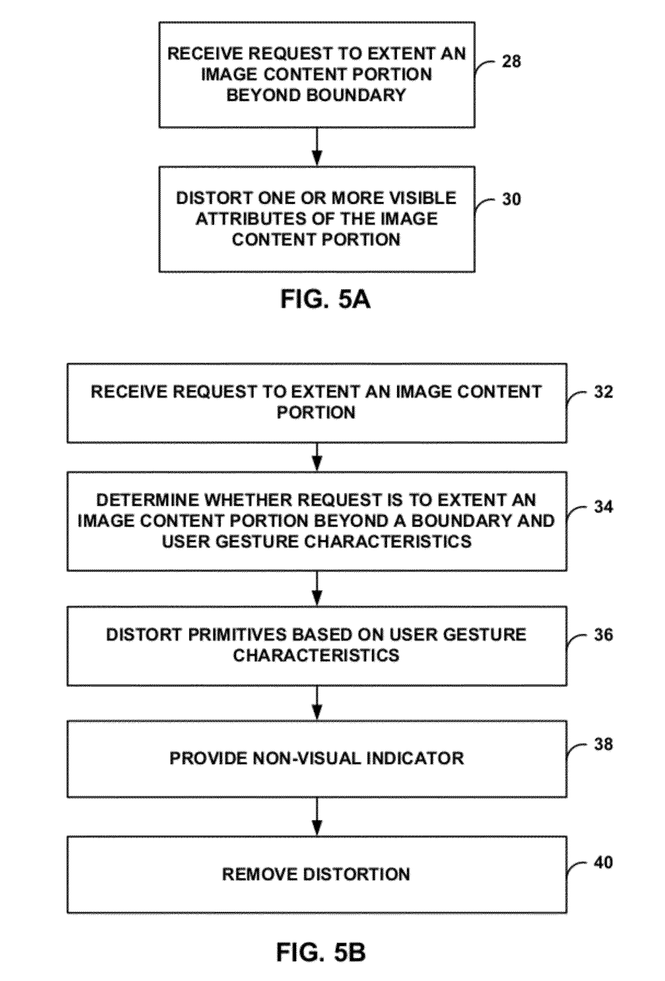

FIG. 5A is a flow chart illustrating an example method of one or more aspects of this disclosure. A request that is based upon a user gesture to extend an image content portion beyond a boundary of the image content may be received (28). The request may be received via at least one processor. The image content portion may be currently displayed on a display screen, e.g., display screen 12. The image content portion may be within the boundary of the image content.

Responsive to the request, one or more visible attributes of the image content portion may be distorted (30). The distortion of the one or more visible attributes may be performed by a means for distorting. The distortion of the one or more visible attributes may indicate recognition of the request. The distortion of the one or more visible attributes may also indicate that the request will not be processed to extend the image content portion beyond the boundary of the image content.

FIG. 5B is a flow chart illustrating another example method of one or more aspects of this disclosure. A request that is based upon a user gesture to extend an image content portion may be received (32). A determination may be made whether the request is a request to extend the image content portion beyond a boundary of the image content, and a determination of the user gesture characteristics of the request (34). Responsive to the request, distortion of one or more primitives that represent the image content portion may be performed based on user gesture characteristics (36). Examples of user gesture characteristics include, but are not limited to, how fast the user applied the user gesture, how many times the user applied the user gesture, the location of the user gesture, e.g., starting and ending locations of the user gesture, an amount the user requested to extend the image content beyond the boundary and the like. Examples of distortion of one or more primitives include warping, curving, and/or shading the one or more primitives that represent the image content portion.

In some examples, in addition to distorting one or more visible attributes of the image content portion, non-visual indicators may be provided in response to the request to extend the image content portion beyond the boundary of the image content (38). Examples of the non-visual indicators include vibrating the device and/or providing a sound from the device. After the distortion to the primitives and/or at the conclusion of the non-visual indicators, the distortions to the image content may be removed (40).

Conventional devices may not be equipped to provide a user with an indication that the user is requesting extending an image content portion beyond the boundary of the image content. In some conventional devices that may provide an indication that the user is requesting extending an image content portion beyond the boundary of the image content, such indications may not be easily seen by the user. Aspects of this disclosure may provide users with a clear indication that the user is requesting extending an image content portion beyond the boundary of the image content.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such a processor or an integrated circuit device, such as an integrated circuit chip or chipset. Alternatively or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as RAM, ROM, NVRAM, EEPROM, FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code or instructions may be software and/or firmware executed by processing circuitry including one or more processors, such as one or more DSPs, general purpose microprocessors, ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

Various aspects have been described in this disclosure. These and other aspects are within the scope of the following claims.

1. A computer-readable storage medium comprising instructions that cause one or more processors of a computing device to:
receive a request that is based upon a user gesture to extend an image content portion of image content beyond a boundary of the image content, wherein the image content portion is currently displayed on a display screen and within the boundary of the image content; and
responsive to receiving the request, distort one or more visible attributes of the image content portion that is displayed on the display screen to indicate recognition of the request and to further indicate that the request will not be processed to extend the image content portion beyond the boundary of the image content.

2. The computer-readable storage medium of claim 1, wherein the boundary of the image content comprises at least one of a scroll boundary and a zoom boundary.

3. The computer-readable storage medium of claim 1, wherein the distortion of the one or more visible attributes comprises at least one of warping, curving, and shading at least one part of the image content portion.

4. The computer-readable storage medium of claim 1, wherein the instructions that cause the one or more processors to distort the one or more visible attributes comprise instructions that cause the one or more processors to distort one or more primitives that represent the image content portion.

5. The computer-readable storage medium of claim 1, wherein the distortion is based on characteristics of the user gesture.

6. The computer-readable storage medium of claim 5, wherein the characteristics of the user gesture include an amount a user requested to extend the image content portion beyond the boundary of the image content, and a location on the display screen where the user requested to extend the image content portion beyond the boundary of the image content.

7. The computer-readable storage medium of claim 1, wherein the instructions that cause the one or more processors to receive the request comprise instructions that cause the one or more processors to receive the request based upon the user gesture that is provided via at least one of the display screen, a keyboard, a mouse, one or more buttons, and a trackball.

8. The computer-readable storage medium of claim 1, wherein the request is received when the image content portion is at the boundary of the image content.

9. The computer-readable storage medium of claim 1, wherein the instructions further comprise instructions that cause the one or more processors to provide a non-visual indicator to indicate recognition of the request and to further indicate that the request will not be processed to extend the portion of the image content beyond the boundary of the image content in response to receiving the request.

10. A method comprising:
receiving, with at least one processor, a request that is based upon a user gesture to extend an image content portion beyond a boundary of the image content, wherein the image content portion is currently displayed on a display screen and within the boundary of the image content; and
responsive to receiving the request, distorting, with the at least one processor, one or more visible attributes of the image content portion that is displayed on the display screen to indicate recognition of the request and to further indicate that the request will not be processed to extend the image content portion beyond the boundary of the image content.

11. The method of claim 10, wherein the boundary of the image content comprises at least one of a scroll boundary and a zoom boundary.

12. The method of claim 10, wherein distorting one or more visible attributes comprises at least one of warping, curving, and shading at least one part of the image content portion.

13. The method of claim 10, wherein distorting the one or more visible attributes comprises distorting one or more primitives that represent the image content portion.

14. The method of claim 10, wherein distorting the one or more visible attributes comprises distorting the one or more visible attributes based on characteristics of the user gesture.

15. A device comprising:
at least one processor configured to receive a request that is based upon a user gesture to extend an image content portion beyond a boundary of the image content, wherein the image content portion is currently displayed on a display screen and within the boundary of the image content; and
means for distorting one or more visible attributes of the image content portion that is displayed on the display screen to indicate recognition of the request and to further indicate that the request will not be processed to extend the image content portion beyond the boundary of the image content, in response to the request.

16. The device of claim 15, wherein the boundary of the image content comprises at least one of a scroll boundary and a zoom boundary.

17. The device of claim 15, wherein the means for distorting comprises an attribute distortion module that is configured to warp, curve, or shade at least one part of the image content portion to distort the one or more visible attributes.

18. The device of claim 15, wherein the means for distorting comprises an attribute distortion module that is configured to distort one or more primitives that represent the image content portion to distort the one or more visible attributes.

19. The device of claim 15, wherein the means for distorting comprises an attribute distortion module that is configured to distort the one or more visible attributes based on the characteristics of the user gesture.

20. The device of claim 15, wherein the at least one processor is further configured to provide a non-visual indicator to indicate recognition of the request and to further indicate that the request will not be processed to extend the portion of the image content beyond the boundary of the image content in response to receiving the request.
